(19) United States
(12) Patent Application Publication
(10) Pub. No.: US 2026/0217137 A1
(43) Pub. Date: Jul. 30, 2026

(54) Electric Off-Road Vehicle

(71) Applicant: Zhejiang CFMOTO Power Co., Ltd., Hangzhou (CN)

(72) Inventors: Xiaolu Jiang, Hangzhou (CN); Yang Tang, Hangzhou (CN); Xianguang Chen, Hangzhou (CN); Zhenyu Zhou, Hangzhou (CN); Feng Bi, Hangzhou (CN); Zihao You, Hangzhou (CN)

(21) Appl. No.: 19/629,039

(22) Filed: Mar. 26, 2026

Related U.S. Application Data
(63) Continuation of application No. PCT/CN2024/099540, filed on Jun. 17, 2024.

(30) Foreign Application Priority Data
Sep. 28, 2023 (CN) 202311282682.5

(51) Int. Cl. B60L 50/64; B60K 1/00; B60K 17/34

(52) U.S. Cl. CPC B60L 50/64; B60K 1/00; B60K 17/34; B60K 2001/005; B60L 2200/22

(57) ABSTRACT

An electric off-road vehicle has a prime mover assembly with a drive motor and a gear reduction unit connected at a connection surface which is offset from a longitudinal midplane by a PMA connection surface offset within a range of 70 to 140mm. A drive shaft extends under the power battery and at least partially within a drive shaft accommodating recess of the power battery, while seating extends at least partially over the power battery. The seating is located at least partially forward of the power battery, with from 52 to 100% of the seating extending over the power battery in plan view. A heat transfer system for the power battery uses a liquid heat transfer medium. The heat transfer system includes a pump located rearward of the power battery and forward of a rear differential.

### RELATED APPLICATION INFORMATION

The present application is a continuation of PCT/CN2024/099540, filed June 17, 2024 and claims priority to Chinese patent application No. 202311282682.5, filed on September 28, 2023, entitled “Electric Off-road Vehicle”, the entire contents both of which are incorporated herein by reference.

### FIELD OF THE DISCLOSURE

The present invention relates to the technical field of motor vehicles, and in particular to an electric off-road vehicle.

### BACKGROUND OF THE DISCLOSURE

With the development of vehicle electrification, off-road vehicles powered by electricity have emerged. However, during the electrification process of off-road vehicles, several problems still remain. The power battery is an important component and energy source of an electric off-road vehicle. The configuration and placement of the power battery not only affect the driving operation of the electric off-road vehicle, but also affect the space utilization of the electrical components and transmission components within the electric off-road vehicle.

### SUMMARY OF THE INVENTION

In the embodiments of the present invention, an electric off-road vehicle is provided to address at least one problem existing in the background art.

In a first aspect, the electric off-road vehicle includes a frame, wheels, a prime mover assembly, a power battery, a drive train, and seating. The frame defines a longitudinal midplane of the off-road vehicle. The wheels include front wheels and rear wheels which support the frame through a suspension system. The prime mover assembly is supported by the frame. The prime mover assembly includes a drive motor and a gear reduction unit connected to the drive motor at a connection surface which is offset from the longitudinal midplane by a PMA connection surface offset. The PMA connection surface offset is within a range of 70 to 140mm. The power battery supplies electricity to the drive motor. The drive train transfers torque from the prime mover assembly to both the front wheels and the rear wheels. A drive shaft of the drive train extends under the power battery. The seating is supported by the frame. The seating is located at least partially forward of the power battery in plan view. From 52 to 100% of the seating extends over the power battery in plan view.

In a second aspect, the electric off-road vehicle further includes a heat transfer system for the power battery. The heat transfer system uses a liquid heat transfer medium. The drive train includes a front differential and a rear differential. The heat transfer system includes a pump located rearward of the power battery and forward of the rear differential.

In a third aspect, the power battery is oriented so as to be longest in width and shortest in height. The power battery defines a drive shaft accommodating recess. The drive shaft is a front drive shaft which extends under the power battery in plan view and is at least partially disposed within the drive shaft accommodating recess.

Compared with the related art, the inventive electric off-road vehicle makes better use of the space between the seating and the frame, reducing impact of the power battery both on driver and passenger space and on space for other components, thereby improving the compactness of the vehicle layout and enhancing driving comfort.

Details of one or more embodiments of the present invention are set forth in the following accompanying drawings and description to make other features, objectives and advantages of the present invention more concise and understandable.

### BRIEF DESCRIPTION OF THE DRAWINGS

The accompanying drawings described herein are used to provide a further understanding of the present invention and form a part of the present application. The illustrative embodiments and their descriptions of the application are used to explain the present invention and are not to be construed as unduly limiting the scope of the present invention. In the accompanying drawings:

FIG. 1 is a front left perspective view of an electric off-road vehicle in accordance with the present invention;

FIG. 2 is a top plan view of a frame, power battery and wheels of the electric off-road vehicle of FIG. 1;

FIG. 3 is a front elevational cross-sectional view, showing part of the frame, the seating, the power battery, part of the front drive shaft and the rear wheels of the electric off-road vehicle of FIG. 1;

FIG. 4 is a rear view of the power battery and heat transfer system of the electric off-road vehicle of FIG. 1;

FIG. 5 is a side view of the heat transfer system and power battery of FIG. 4;

FIG. 6 is another front elevational cross-sectional view, showing part of the frame and part of the vehicle cover, the seating, the power battery and the rear wheels of the electric off-road vehicle of FIG. 1;

FIG. 7 is a schematic diagram of the battery assembly and control system of the electric off-road vehicle of FIG. 1;

FIG. 8 is a top plan view of the prime mover assembly, drive train, and wheels of the electric off-road vehicle of FIG. 1;

FIG. 9 is a cross-sectional plan view of the prime mover assembly and rear differential of FIG. 8;

FIG. 10 is a front right perspective view of the prime mover assembly and rear differential of FIGS. 7 and 8 supported from a portion of the rear frame of FIG. 2 by a support cradle;

FIG. 11 is a rear right perspective view of the prime mover assembly, rear differential, portion of the rear frame and support cradle of FIG. 10;

FIG. 12 is a right side view of the prime mover assembly, rear differential, portion of the rear frame and support cradle of FIGS. 9 and 10;

FIG. 13 is a left side view of the prime mover assembly, rear differential, portion of the rear frame and support cradle of FIGS. 9-11;

FIG. 14 is a top plan view of the power battery and heat transfer system of FIGS. 4 and 5 together with a charging and distributing integration system of the electric off-road vehicle of FIG. 1, and schematically showing the drive motor of FIGS. 8 and 9;

FIG. 15 is a rear elevational view of the charging and distributing device of FIG. 14 relative to the drive motor of FIGS. 8 and 9 and the cargo area of the electric off-road vehicle of FIG. 1;

FIG. 16 is a top plan view of the frame, power battery and wheels of FIG. 16 relative to the charging and distributing device of FIGS. 14 and 15;

FIG. 17 is a rear left perspective view of the charging and distributing support relative to portions of the frame of FIGS. 2 and 16;

FIG. 18 is a rear elevational view of the charging and distributing support and frame portions of FIG. 17 relative to the charging and distributing device of FIGS. 14-16 and drive motor of FIGS. 8, 9 and 15;

FIG. 19 is a rear elevational view of drive motor of FIGS. 8, 9, 15 and 18 and the charging and distributing integration system of FIG. 14 relative to the rear frame, rear wheels, rear suspension and cargo area of the electric off-road vehicle of FIG. 1;

FIG. 20 is a left side view of the rear frame, rear wheels, rear suspension, cargo area, drive motor and charging and distributing integration system of FIG. 19.

### DETAIL DESCRIPTION

The present invention will be described in detail below with reference to specific embodiments shown in the accompanying drawings. However, these embodiments are not intended to limit the present invention, and structural, methodological, or functional modifications made by those of ordinary skill in the art based on these embodiments shall fall within the scope of protection of the present invention.

It should be noted that when an element is described as being "disposed on" another element, it may be directly on the other element or may be disposed on one or more intermediate element(s) located therebetween. When an element is described as being "connected to " or being “coupled to” another element, it may be directly connected to or coupled to the other element or may be connected or coupled via one or more intermediate element(s). In general, the terms "left," "right," and similar expressions used herein are for illustrative purposes only and are not intended to limit the embodiments of the present invention, particularly in that the entire vehicle and/or many components of the preferred vehicle can be laid out in a left-right mirror image to the preferred embodiment shown.

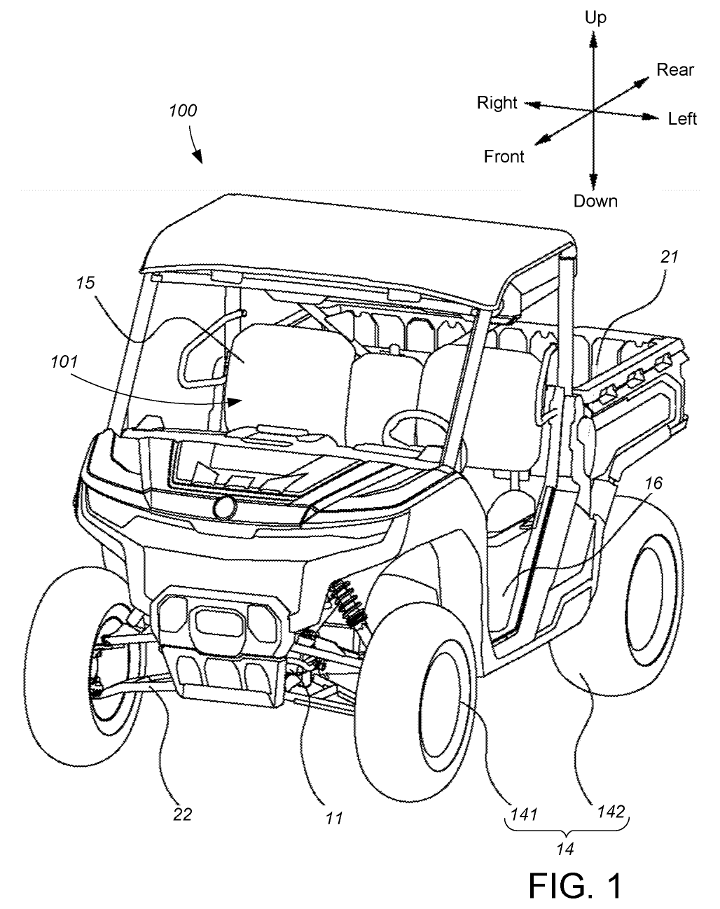

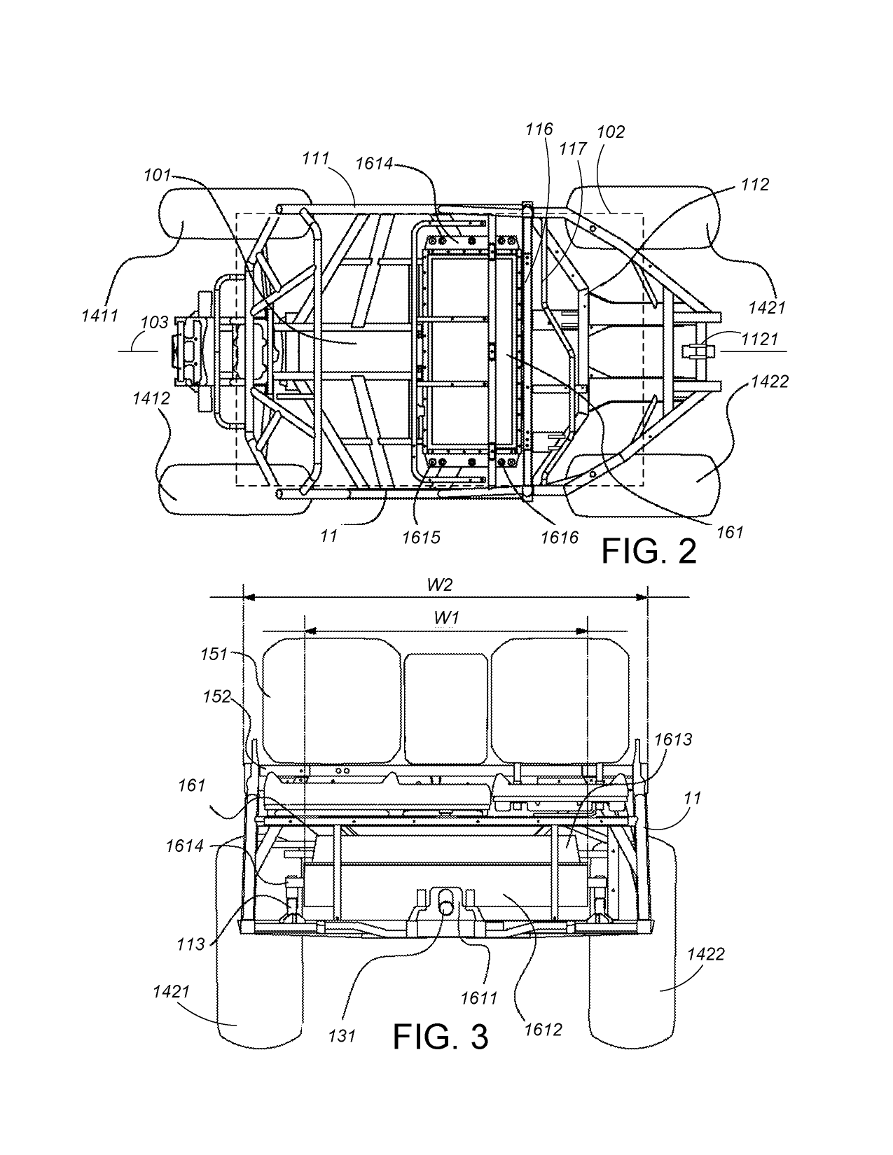

As shown in FIGS. 1, 2 and/or 8, the present invention provides an electric off-road vehicle 100 which includes a frame 11, a prime mover assembly 12, a drive train 13, a plurality of wheels 14, seating 15, a cargo area 21 and a suspension system 22. The frame 11 includes a midframe 111 which defines a cockpit 101 for a driver and possibly one or more passengers and a rearframe 112 located rearward of the cockpit 101. The rearframe 112 is mainly used to house and support the prime mover assembly 12. The plurality of wheels 14 includes a pair of front wheels 141 and a pair of rear wheels 142, supporting the frame 11 via the suspension system 22. The prime mover assembly 12 is coupled to and transmits power to at least one of the front wheels 141 or the rear wheels 142 via the drive train 13. The seating 15 is supported by the midframe 111 for providing support for the driver and passengers, preferably including at least two seats 151 disposed side-by-side in a width direction of the electric off-road vehicle 100 and in front of the cargo area 21.

For better understanding of the present invention, orientations of “front”, “rear”, “left”, “right”, “up”, and “down” are shown in FIG. 1. In the description of the present invention, it should be noted that the terms “length direction”, “longitudinal” and reference numerals beginning with “L” refer to a front-rear direction of the vehicle 100, the terms “width direction”, “lateral”, “transverse” and reference numerals beginning with “W” refer to a left-right direction of the vehicle 100, and the terms “height direction”, “vertical” and reference numerals beginning with “H” refer to an up-down direction of the vehicle 100, all generally considering the vehicle 100 to be on flat ground and headed forward.

As shown in FIGS. 3 and 8, the drive train 13 includes a front drive shaft 131 extending in the length direction of the electric off-road vehicle 100. The prime mover assembly 12 is coupled to the front wheels 141 in a transmission mode by the front drive shaft 131, so that the prime mover assembly 12 can drive the electric off-road vehicle 100 to move. The front wheels 141 include a front-right wheel 1411 and a front-left wheel 1412, and the rear wheels 142 include a rear-right wheel 1421 and a rear-left wheel 1422. The drive train 13 includes a front drive axle 132 mounted between the front-right wheel 1411 and the front-left wheel 1412 and a rear drive axle 133 mounted between the rear-right wheel 1421 and the rear-left wheel 1422. The front drive axle 132 and the rear drive axle 133 are preferably differentials and will subsequently referred to as such, but might alternatively provide torque transmission to drive the respective front right and left wheels 1411, 1412 or rear left and right wheels 1421, 1422 always at the same rotational speed.

The electric off-road vehicle 100 further includes a battery assembly 16 including a power battery 161 for providing energy to the prime mover assembly 12. The power battery 161 is preferably a unit of one or more lithium batteries. The power battery 161 is disposed on the frame 11 between the front differential 132 and the rear differential 133, preferably oriented so as to be longest in width and shortest in height. The seating 15 includes seats 151 and a seat bracket 152 that attaches the seats 151 to the frame 11. The power battery 161 is at least partially disposed between the seat bracket 152 and the frame 11 so as to provide adequate installation space for the power battery 161. In addition, the seat bracket 152 can provide protection for the power battery 161, avoiding damage to the power battery 161 which could be caused by impact during driving of the electric off-road vehicle 100, and improving the safety and service life of the power battery 161.

The front drive shaft 131 extends underneath the power battery 161. More particularly, a drive shaft accommodating recess 1611 is defined on a bottom side of the power battery 161 extending longitudinally. The front drive shaft 131 is at least partially disposed within the drive shaft accommodating recess 1611. The front drive shaft 131 thus at least partially overlaps the power battery 161 both in plan view and in side view. The inner contour of the drive shaft accommodating recess 1611 is shaped to substantially conform to the outer contour of the front drive shaft 131, increasing space utilization. The drive shaft accommodating recess 1611 allows for the power battery 161 to be installed at a lower position without altering the overall drive train configuration, reducing the center of gravity of the vehicle 100 and improving stability.

The seating 15 is at least partially located forward of the power battery 161 in plan view, keeping the power battery 161 from protruding forwardly from the front end of the seating 15, thereby avoiding interference of the power battery 161 into leg placement space of the driver and/or passenger. The power battery 161 has a relatively large size and is preferably also positioned at least partially rearward of the seating 15 in plan view, but still far enough forward that installation of other components is not adversely affected. This preferred location of the power battery 161 helps ensure proper weight distribution within the electric off-road vehicle 100.

Preferably from 65 to 100% of the power battery 161 extends under the seating 15 in plan view, more preferably 72 to 90%, and most preferably 78 to 80%. The seating 15 is generally about the same size or slightly larger than the power battery 161 in plan view, and preferably from 52 to 100% of the seating 15 extends over the power battery 161 in plan view, more preferably 60 to 90%, and most preferably 67 to 83%. These preferred amounts of plan view overlap between the power battery 161 and the seating 15 avoid positioning the power battery 161 excessively rearward so as to occupy space needed for other components, enhancing space utilization in the electric off-road vehicle 100.

As shown in FIG. 2, a wheel area 102 can be defined as the area enclosed by sequentially connecting center points of the front-right wheel 1411, the front-left wheel 1412, the rear-right wheel 1421, and the rear-left wheel 1422. The power battery 161 is considerably smaller than and entirely within the wheel area 102 in plan view, with the power battery 161 preferably extending for about 9 to 17% of the wheel area 102, more preferably extending for 10 to 16% of the wheel area 102, and most preferably extending for about 12 to 14% of the wheel area 102. This preferred plan view size of the power battery 161 relative to the wheel area 102 allows for an appropriate size and weight distribution of the power battery 161 while leaving adequate space for other components.

As shown in FIG. 3, the power battery 161 has a maximum power battery width W1, and the frame 11 has a maximum frame width W2. A power battery width ratio W1/W2 of the maximum power battery width W1 to maximum frame width W2 is preferably in the range from 0.5 to 1, more preferably in the range from 0.6 to 0.9, and most preferably in the range from 0.7 to 0.8. A power battery width ratio W1/W2 in the preferred range allows the power battery 161 to be substantially positioned below the seating 15 while still allowing adequate support for the seating 15.

The power battery 161 preferably includes a lower battery housing 1612 connected to an upper battery housing 1613 which jointly surround, contain and protect a battery module unit (not separately shown). The drive shaft accommodating recess 1611 is provided in the lower battery housing 1612. Particularly at the low position of the power battery 161, the protection provided by the lower battery housing 1612 and the upper battery housing 1613 can avoid damage to the battery module unit from external impacts, improving the safety and service life of the battery module unit.

A battery mounting structure 1614 is provided for fixing the power battery 161 to the frame 11. The battery mounting structure 1614 includes a plurality of connecting portions 1615 preferably located on left and right sides of the lower battery housing 1612 for attachment to the frame 11, as well as a plurality of lifting portions 1616. The frame 11 is provided with a plurality of battery support bases 113 each in abutment with and below one of the connection portions 1612b of the battery mounting structure 1614. During installation of the power battery 161, the connecting portions 1615 are snapped onto the battery support bases 113, and then the connecting portions 1615 are secured to the battery support bases 113 by fasteners such as bolts (not shown). The arrangement of the connecting portions 1615 and the battery support bases 113 assures solid contact area between the lower battery housing 1612 and the frame 11, enhancing connection strength between the power battery 161 and the frame 11 and further improving operational stability of the power battery 161. The connecting portions 1615 are preferably integrally formed (i.e., manufactured simultaneously) with the lower battery housing 1612. The integrally formed structure enhances the strength of the connecting portions 1615 to avoid detachment, and also reduces the assembly process to lower manufacturing cost. The connecting portions 1615 could alternatively be removably attached to the lower battery housing 1612, enhancing adaptability for different battery and frame shapes and sizes.

The lifting portions 1616 can be used to connect with an external tool (not shown) to more easily enable removal or positional replacement of the power battery 161. In the preferred embodiment, the battery mounting structure 1614 includes four lifting portions 1616.

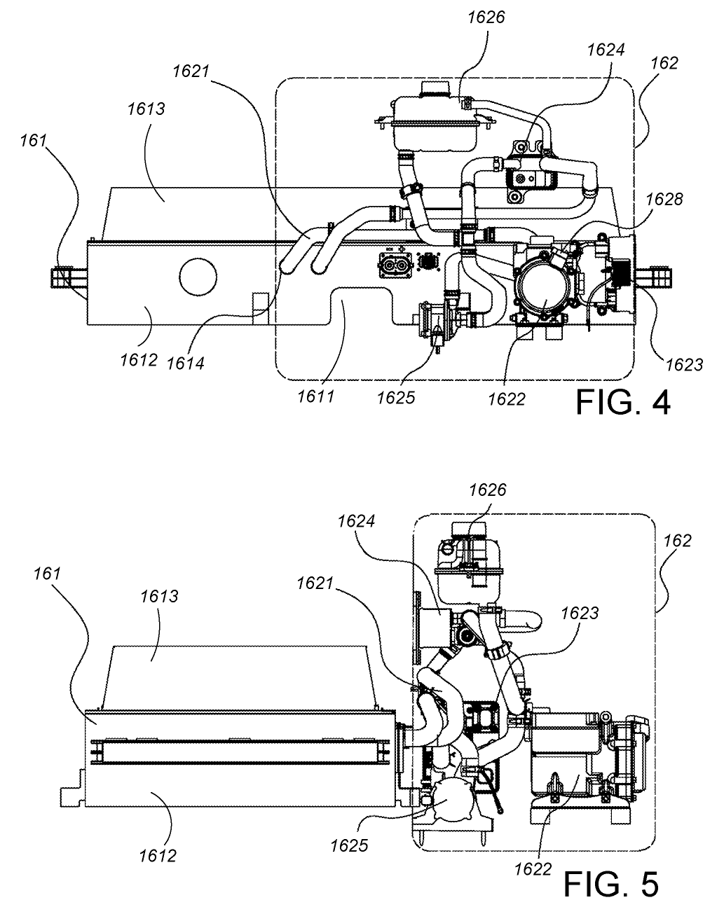

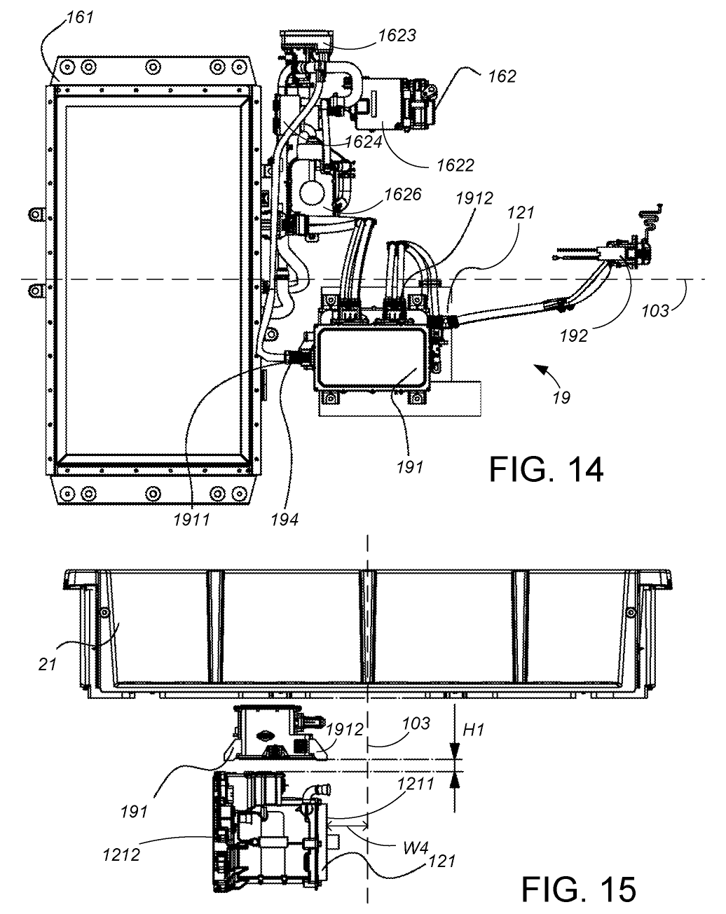

The battery assembly 16 further includes a heat transfer system 162 best shown in FIGS. 4, 5 and 7, and also shown in FIG. 14. The heat transfer system 162 is preferably substantially located rearward but close to the power battery 161, and forward of the rear differential 133. The heat transfer system 162 primarily uses a liquid heat transfer medium such as water, coolant, antifreeze etc., to selectively warm the power battery 161 or cool the power battery 161 as needed. The term “water” is used hereinafter merely for ease of reference when referring to the liquid heat transfer medium of the heat transfer system 162, regardless of its liquid composition. Accordingly, the power battery 161 can be considered either water-heated or water-cooled based upon operating conditions. Secondarily, the heat transfer system 162 can use a refrigerant to cool the water when needed, and the refrigerant may cycle through liquid and gaseous phases. Viewed from the rear of the electric off-road vehicle 100, the heat transfer system 162 at least partially overlaps the power battery 161. Locating the heat transfer system 162 close to the power battery 161 shortens pipeline and wiring connections.

The heat transfer system 162 includes an inner water circulating pipeline (not shown) disposed within the power battery 161 and an external water circulating pipeline 1621 connected to the inner circulating pipeline at a connection port 1614 located at the rear side of the power battery 161. The heat transfer system 162 includes a refrigerant compressor 1622, a water heater 1623, an evaporator heat exchanger 1624, a water pump 1625, a water reservoir 1626 and a refrigerant condenser 1627 (shown only in FIG. 7). The water heater 1623, the evaporator heat exchanger 1624, the water pump 1625 and the water reservoir 1626 are all connected by the circulating pipeline 1621. The heat transfer system 162 further includes a refrigerant pipeline 1628 for refrigerant circulation, and the compressor 1622, the evaporator heat exchanger 1624 and the condenser 1627 are all connected by the refrigerant pipeline 1628. Both water and refrigerant separately flow through and are capable of exchanging heat in the evaporator heat exchanger 1624, selectively cooling the liquid water (or other coolant) in the circulating pipeline 1621. The circulating pipeline 1621 flows at least partially through the water heater 1623 which selectively heats water flowing through the circulating pipeline 1621. In the preferred embodiment, the water heater 1623 is a Positive Temperature Coefficient (PTC) water heater. The water pump 1625 provides circulating water pressure. The water reservoir 1626 balances the water (or other liquid coolant) volume. The cooling and heating of the power battery 161 is realized through water (or other liquid coolant) circulating through the closed loop of the water circulating pipeline 1621, independent of other circuits.

The layout of the preferred heat transfer system 162 locates the water heater 1623 and the water pump 1625 in close proximity behind the power battery 161. The evaporator heat exchanger 1624 is located above the water heater 1623 and the compressor 1622, thereby preventing the evaporator heat exchanger 1624 from being excessively close to the water heater 1623 or the compressor 1622, which could otherwise cause interference between the evaporator heat exchanger 1624 and the water heater 1623 or the compressor 1622. This arrangement helps improve the operational stability of the evaporator heat exchanger 1624, the water heater 1623, and the compressor 1622. Preferably, the water heater 1623 is provided in front of the compressor 1622. Compared to the water heater 1623, the compressor 1622 has a larger volume. The forward arrangement of the water heater 1623 can shorten the length of the circulating pipeline 1621, and can also improve operating efficiency of the heat transfer system 162, as the rearward position of the compressor 1622 has a relatively small impact on the cooling efficiency. By arranging the water heater 1623 in front of the compressor 1622, the length of the water circulating pipeline 1621 can be reduced. Furthermore, the heating efficiency of the water heater 1623 can be enhanced while ensuring the efficiency of the compressor 1622. The water pump 1625 is disposed close to the power battery 161, further shortening the circulating pipeline 1621 and thereby increasing pumping efficiency. The water reservoir 1626 is disposed above the water pump 1625, at least partially overlapping the water pump 1625 in plan view. The relatively elevated position of the water reservoir 1626 allows water to gravitationally flow from the water reservoir 1626 to the circulating pipeline 1621. Each component in the heat transfer system 162 is separated from the power battery 161 via an air gap, preventing interference and conductive heat transfer between the heat transfer system 162 and the power battery 161. In summary, the preferred heat transfer system 162 itself works efficiently to ensure that the power battery 161 operates at an efficient temperature, while the length of the circulating pipeline 1621 is reduced and the complexity of the connections is reduced to lower the overall cost of the electric off-road vehicle 100.

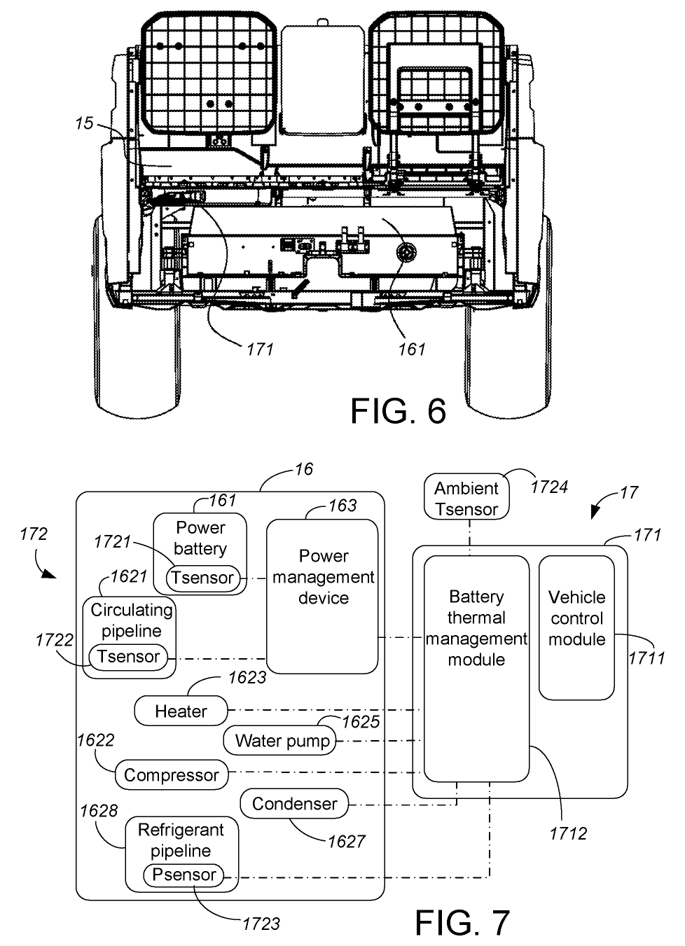

The electric off-road vehicle 100 includes a control system 17 with a vehicle controller 171 as shown in FIGS. 6 and 7. The vehicle controller 171 is used to control operation of the electric off-road vehicle 100. As shown in FIG. 6, the vehicle controller 171 is located between the power battery 161 and the seating 15. The vehicle controller 171 has a relatively small size, and the vehicle controller 171 substantially (or more preferably entirely) overlaps with both the power battery 161 and the seating 15 in plan view. At the same time, disposing the vehicle controller 171 between the power battery 161 and the seating 15 provides protection for the vehicle controller 171, so as to prevent damage to the vehicle controller 171 resulting from impacts during operation of the electric off-road vehicle 100, while also shielding the vehicle controller 171 from dust and sand raised during operation of the electric off-road vehicle 100, improving cleanliness of the vehicle controller 171. It is possible to entirely expose the vehicle controller 171 by removing the seating 15, reducing the difficulty of installing, maintaining or replacing the vehicle controller 171. Preferably, the vehicle controller 171 is fixed directly to the bottom of the seating 15, or directly to the top of the power battery 161, or indirectly to the bottom of the seating 15 or the top of the power battery 161 by means of a fixing member such as a mount (not shown).

As shown in FIG. 7, the vehicle controller 171 includes a vehicle control module 1711 and a battery thermal management module 1712. The vehicle control module 1711 is used to control the operation of the electric off-road vehicle 100. The battery thermal management module 1712 is used to regulate operating temperature of the power battery 161 by controlling the heat transfer system 162, so the power battery 161 always operates at a suitable temperature. The battery assembly 16 further includes a power management device 163, and the control system 17 includes one or more sensors 172. The power management device 163 controls the overall operation of the power battery 161, in particular charging and discharging of the power battery 161, so that the power battery 161 operates in a stable state to avoid malfunctions and dangers. Temperature of the power battery 161 is an important parameter during the operation of the power battery 161, and can indicate operation state of the power battery 161. A battery temperature sensor 1721 is preferably disposed in the power battery 161, and the overall temperature of the power battery 161 and the temperature of the battery module therein are obtained by the battery temperature sensor 1721. A water temperature sensor 1722 is preferably installed in the exterior water circulation pipeline 1621 or more preferably the interior water circulation pipeline of the power battery 161, to directly detect and acquire the temperature of the water (or other coolant), thereby ensuring stable operation of the heat transfer system 162 and enabling timely detection of potential operational issues of the power battery 161.

The power management device 163 is electrically connected to the battery temperature sensor 1721 and the water temperature sensor 1722, so the power management device 163 can adjust charging, discharging and/or other battery operations based on sensed temperature of the battery module in the power battery 161 and/or sensed temperature of the water. The power management device 163 is electrically connected to the battery thermal management module 1712, and the power management device 163 transmits temperature data of the battery module in the power battery 161 and/or the coolant in the circulating pipeline 1621 to the battery thermal management module 1712.

The control system 17 further includes a pressure sensor 1723 disposed in the refrigerant pipeline 1628. The pressure sensor 1723 is electrically connected to the battery thermal management module 1712, transmitting refrigerant pressure readings to the battery thermal management module 1712. Pressure in the refrigerant pipeline 1628 has an important relationship to the temperature and operating condition of refrigerant in the heat transfer system 162. Detected pressure provides the battery thermal management module 1712 with more basis for accurately controlling the compressor 1622.

The heat transfer system 162 preferably further includes an ambient temperature sensor 1724 for detecting ambient air temperature of the environment in which the electric off-road vehicle 100 is being used. The ambient temperature sensor 1724 is electrically connected to the battery thermal management module 1712 and transmits ambient air temperature readings to the battery thermal management module 1712.

The battery thermal management module 1712 is electrically connected to the water heater 1623, the compressor 1622, the water pump 1625, and the condenser 1627, for independent controlling of each. Signaling between the battery thermal management module 1712 and the water heater 1623, the compressor 1622, the water pump 1625 and the condenser 1627 in the heat transfer system 162 is preferably realized through a CAN (Controller Area Network) communication connection, but alternatively can be through a LIN (Local Interconnect Network) communication connection or separate hardwire communication connections. Not all of the signaling with the battery thermal management module 1712 needs to be through the same type of communications. For example, in one embodiment the battery thermal management module 1712 can wake up the water heater 1623 and the compressor 1622 and can control the condenser 1627 via hardwired signals, can transmit control signals and receive feedback from the water heater 1623 and the compressor 1622 via CAN, and can perform control signaling and information feedback with the water pump 1625 via LIN. CAN communications have advantages of accurate and fast transmission of signals and data with reduced wiring. LIN communications also have a relatively high signal and data transfer speed and the information transfer bandwidth is able to meet the control of the battery thermal management module 1712 and the components described above. Hardwired communications offer advantages of simplicity and convenience, and can reduce costs while meeting the requirements of signal transmission, albeit usually with higher wiring costs. A suitable and efficient signaling method can be optimally selected between the battery thermal management module 1712 and different devices based on differences in the types of devices and differences in the signals transmitted.

The battery thermal management module 1712 controls the heat transfer system 162 according to the acquired battery module temperature, water temperature, refrigerant pressure and ambient temperature readings. When the temperature sensor(s) 1721 and/or 1722 detect(s) that temperature of the power battery 161 is too high, the battery thermal management module 1712 controls the compressor 1622 and the water pump 1625 in the heat transfer system 162 to begin to work to reduce water temperature, pumping cooled water and thereby cooling the power battery 161, so as to enable the power battery 161 to operate in a suitable temperature range. When the temperature sensor(s) 1721 and/or 1722 detect(s) that temperature of the power battery 161 is too low, the battery thermal management module 1712 controls the water heater 1623 and the water pump 1625 in the heat transfer system 162 to begin to work to heat increase water temperature, pumping heated water and thereby heating the power battery 161, so that the power battery 161 can operate in a suitable temperature range. The battery thermal management module 1712 is further capable of adjusting management and control of the heat transfer system 162 in accordance with acquired refrigerant pressure and ambient temperature. Thermal management requirements of the power battery 161 are met so as to improve operation of the power battery 161.

As shown in FIG. 8, the prime mover assembly 12 includes an electric drive motor 121 capable of generating a driving torque and a gear reduction unit 122 to receive and increase torque and reduce rotational speed of the drive motor output. The gear reduction unit 122 is coupled to the rear differential 133 for torque transmission, thereby driving the rear wheels 142 to move. While the gear reduction unit 122 could be coupled to the rear differential 133 through a rear drive shaft (not shown), more preferably the rear differential 133 is directly mounted on the gear reduction unit 122. Direct mounting of the rear differential 133 on the gear reduction unit 122 reduces the overall footprint of the prime mover assembly 12 and the rear differential 133, improves the structural compactness and spatial efficiency of the electric off-road vehicle 100, and contributes to lightweight design of the electric off-road vehicle 100. The gear reduction unit 122 is selectively coupled to the front differential 132 through the front drive shaft 131, for torque transmission driving the front wheels 141 to move. A longitudinal midplane 103 is defined perpendicular to the width direction of the electric off-road vehicle 100 and centered widthwise relative to the off-road vehicle 100. The front drive shaft 131 is at least partially intersected by the longitudinal midplane 103.

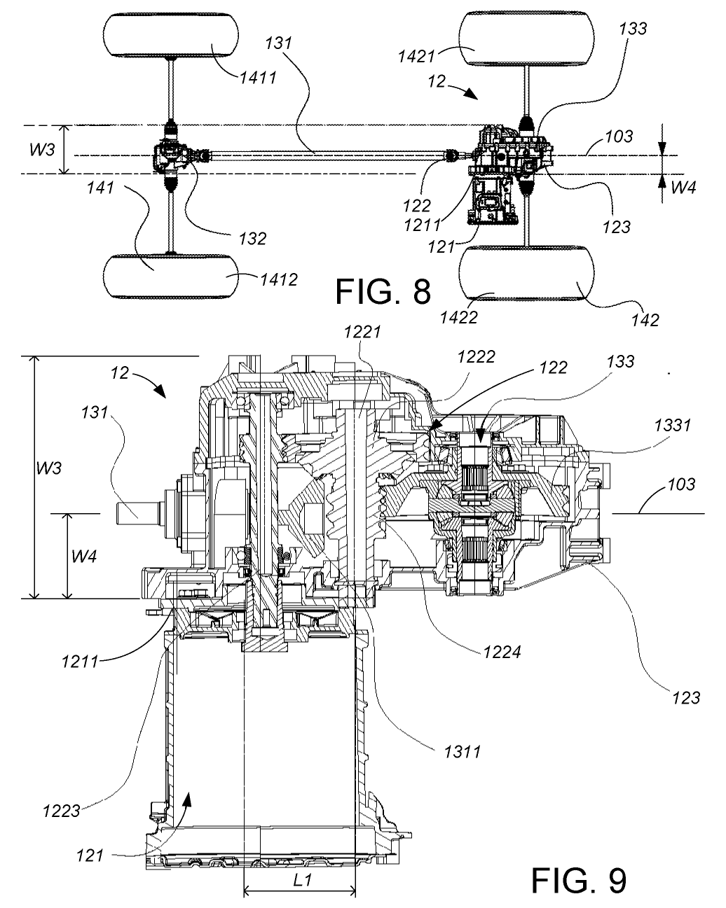

As best shown in FIG. 9, the gear reduction unit 122 includes a power input shaft 1223 that receives torque from the drive motor 121. The gear reduction unit 122 further includes a power transmission shaft 1221 arranged substantially parallel to the power input shaft 1223, gear meshed with the power input shaft 1223. The power transmission shaft 1221 has a bevel gear 1222 and a power output gear 1224. A ring gear 1311 is provided at the rear end of the front drive shaft 131 in engagement with the bevel gear 1222 for torque transfer through gear meshing. The front differential 132 includes a front bevel gear 1321 (shown in FIG. 8) receiving torque from the front drive shaft 131. The rear differential 133 is provided with a rear bevel gear 1331 that meshes with the power output gear 1224 to receive torque from the power transmission shaft 1221.

To maintain the same direction of rotation of the front bevel gear 1321 of the front differential 132 and the rear bevel gear 1331 of the rear differential 133, the bevel gear 1222 on the power transmission shaft 1221, the front bevel gear 1321 and the rear bevel gear 1331 are all at least partially located on the same (in the preferred embodiment, right) side of the longitudinal midplane 103. The gear reduction unit 122 is preferably located toward that same (right) side of the longitudinal midplane 103, and the drive motor 121 is located substantially or entirely on the opposite (left) side of the longitudinal midplane 103. Locating a majority of the gear reduction unit 122 opposite the drive motor 121 relative to the longitudinal midplane 103 also helps balance the center of gravity of the prime mover assembly 12 in the vehicle 100.

The axis of the power input shaft 1223 is longitudinally offset by a gearshaft separation distance L1 from the axis of the power transmission shaft 1221. The gearshaft separation distance L1 is preferably in the range from 74 to 138 mm, more preferably in the range from 84 to 128 mm, and most preferably in the range from 95 to 116 mm, with the power transmission shaft 1221 rearward of the power input shaft 1223. Having a gearshaft separation distance L1 in the preferred range allows for an acceptable gear ratio in the gear reduction unit 122 while keeping the gear reduction unit 122 as small as possible but allowing transfer of sufficient torque with minimal wear.

The rear bevel gear 1331 on the rear differential 133 is preferably constantly engaged with the power output gear 1224 on the power transmission shaft 1221, such that torque transmission is always maintained between the gear reduction unit 122 and the rear differential 133. Conversely, the ring gear 1311 and the bevel gear 1222 have a mutual engagement state and a disengaged state. When the ring gear 1311 of the front drive shaft 131 and the bevel gear 1222 are in the mutual engagement state, the vehicle 100 operates in four wheel drive. When the ring gear 1311 of the front drive shaft 131 and the bevel gear 1222 are in the disengaged state, the vehicle 100 operates more efficiently in rear wheel drive.

The gear reduction unit 122 has a gear reduction width W3. The gear reduction unit 122 extends through the longitudinal midplane 103 with a majority of the gear reduction unit 122 on a side of the longitudinal midplane 103 away from the drive motor 121. More particularly, the gear reduction unit 122 connects to the drive motor 121 at a connection surface 1211 which is offset from the longitudinal midplane 103 by a PMA connection surface offset W4. The PMA connection surface offset W4 is preferably in the range from 70 to 140 mm, more preferably in the range from 85 to 125 mm, and most preferably in the range from 95 to 115 mm. The PMA connection surface offset W4 is preferably 34 to 49% of the gear reduction width W3, more preferably 37 to 47% of the gear reduction width W3, and most preferably 40 to 44% of the gear reduction width W3. An appropriately sized PMA connection surface offset W4, both by itself and as a percentage of gear reduction width W3, allows the front and rear differentials 132, 133 to be substantially centered on the longitudinal midplane 103 while keeping the center of gravity of the prime mover assembly 12 adequately balanced in the off-road vehicle 100, improving driving stability of the electric off-road vehicle 100.

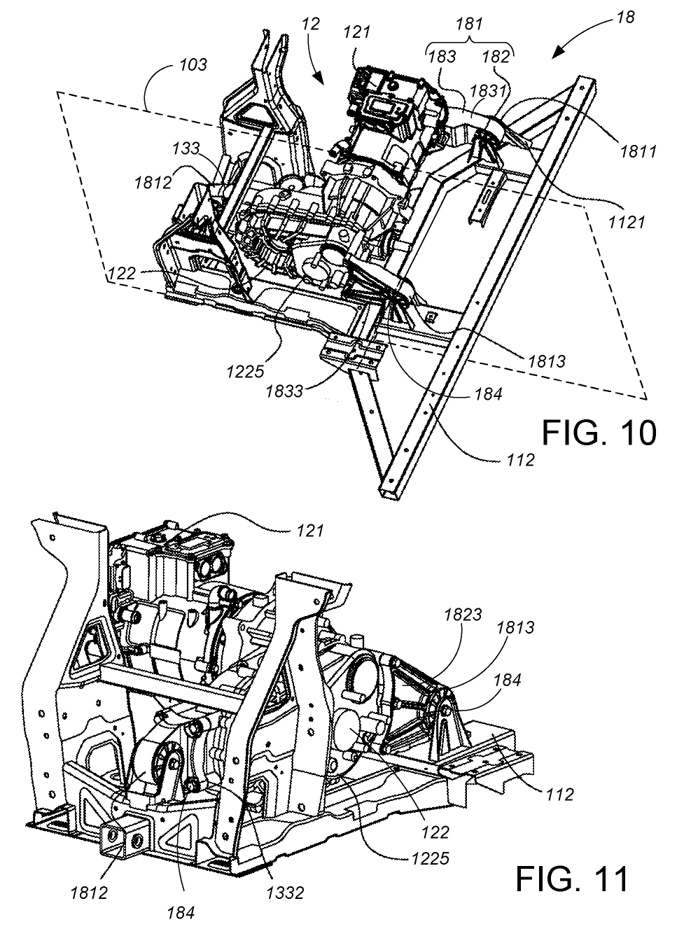

The prime mover assembly 12 of the electric off-road vehicle 100, including the rear differential 133, is supported on the frame 11 using a support cradle 18 as shown in FIGS. 10-13. The support cradle 18 is designed to attenuate vibration transmission between the prime mover assembly 12 and the frame 11. The support cradle 18 preferably includes three support hangers 181, namely, a left-front hanger 1811, a rear hanger 1812, and a right-front hanger 1813, though other embodiments utilize more than three support hangers 181. The left-front hanger 1811 is disposed on the left side of the longitudinal midplane 103, at least a portion of the rear hanger 1812 is preferably disposed on the longitudinal midplane 103, and the right-front hanger 1813 is disposed on the right side of the longitudinal midplane 103. The rear hanger 1812 is preferably disposed at a higher elevation than either the left-front hanger 1811 or the right-front hanger 1813. Each support hanger 181 includes a bushing 182 for providing cushioning and a bracket 183 for connecting the prime mover assembly 12 relative to the bushing 182. The rear frame 112 includes two hanger mounting ears 1121 for each support hanger 181, and a bushing fastener 184 such as a bolt is used to secure the bushing 182 to the respective mounting ears 1121. The three bushing fasteners 184 preferably each extend transversely. Each bracket 183 extends longitudinally, cantilevering weight of the prime mover assembly 12 relative to its bushing fastener 184. The bushing 182 is formed of an elastic material so as to reduce the vibration transmission between the prime mover assembly 12 and the frame 11. The three support hangers 181 provide a triangular support cradle 18 which improves connection stability and connection strength.

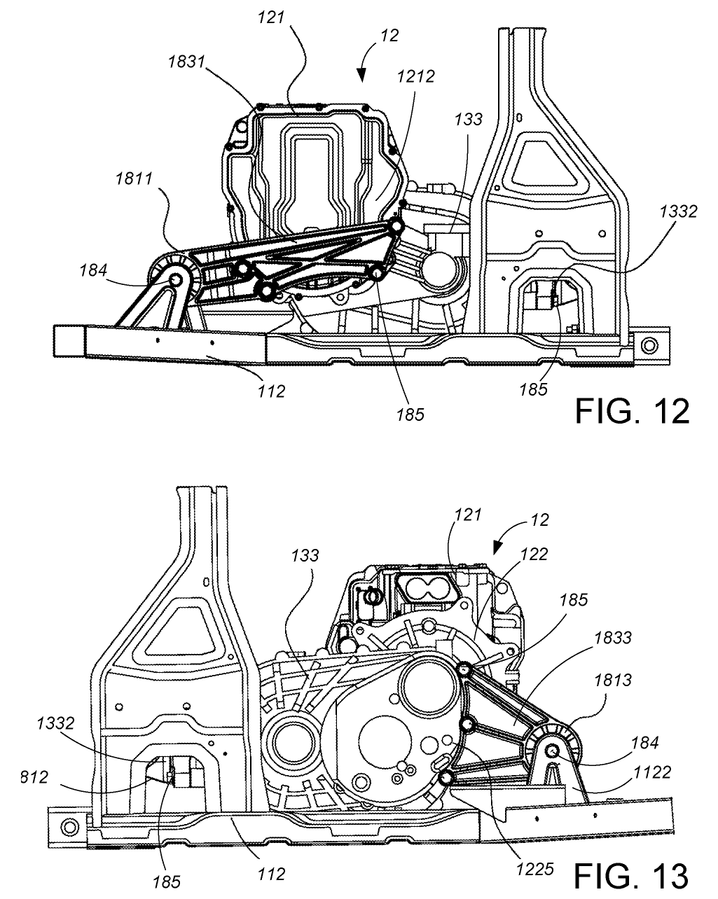

The bracket 1831 of the left-front hanger 1811 preferably attaches on a longitudinally-extending vertical outer surface 1212 of the drive motor 121, such as by using four transversely-extending attachment bolts 185 as best shown in FIG. 12. The bracket 1832 of the rear hanger 1812 preferably attaches on a transversely-extending vertical rear surface 1332 of the rear differential 133, such as by using four longitudinally-extending attachment bolts 185 as best shown in FIG. 11. The bracket 1833 of the right-front hanger 1813 preferably attaches on a longitudinally-extending vertical outer surface 1225 of the gear reduction unit 122, such as by using three transversely-extending attachment bolts 185 as best shown in FIGS. 11 and 13. By having attachment bolts 185 which extend both transversely and longitudinally depending upon which of the brackets 1831, 1832, 1833 are being attached, the support cradle 18 better absorbs forces of the prime mover assembly 12 relative to the rear frame 11, improving connection stability.

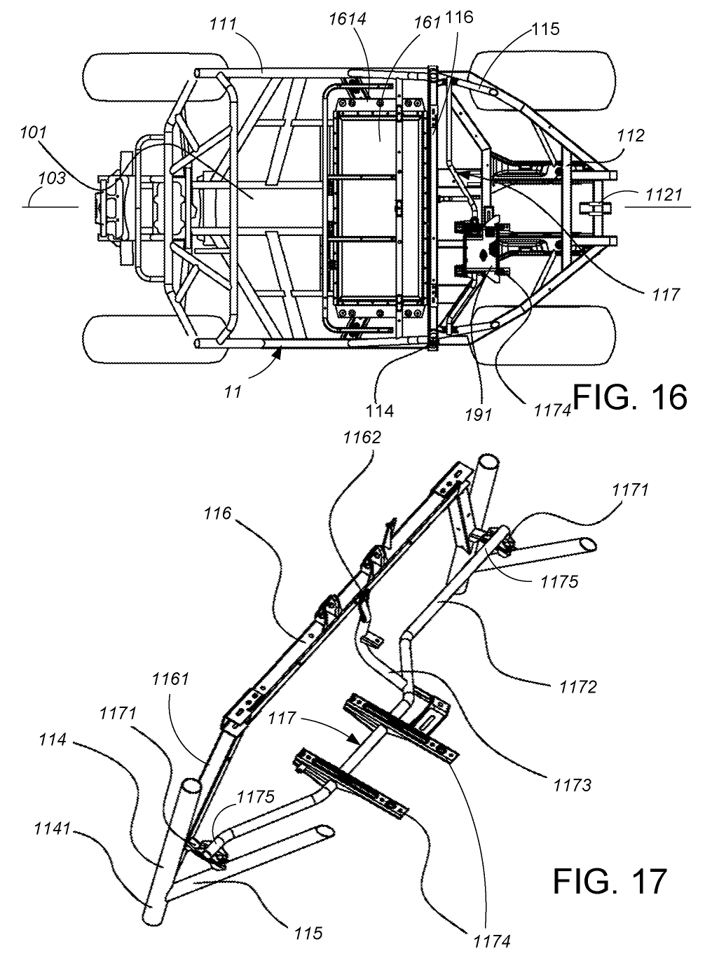

The electric off-road vehicle 100 includes a charging and distributing integration system 19 electrically coupled to both the power battery 161 and the drive motor 121 of the prime mover assembly 12 as best understood with reference to FIGS. 14-18. The charging and distributing integration system 19 is used to control inputs and outputs of electrical energy in the power battery 161. The charging and distributing integration system 19 includes a charging and distributing device 191 disposed at least partially on a rear side of the power battery 161, above the prime mover assembly 12. Specifically, the charging and distributing device 191 is located above the drive motor 121, both preferably on the left side of the longitudinal midplane 103. The charging and distributing device 191 is capable of a) converting alternating current power input from an external power source into direct current power for charging the power battery 161; b) stepping down voltage output by the power battery 161 for use by low-voltage electrical devices in the electric off-road vehicle 100; and c) controlling the power battery 161 to supply electrical energy to high-voltage electrical components such as the drive motor 121 in the electric off-road vehicle 100. The charging and distributing device 191 includes a battery port 1911 electrically connected to the battery assembly 16 and a motor port 1912 electrically connected to the drive motor 121. The battery port 1911 is preferably located at the front end of the charging and distributing device 191 close to the power battery 161, and the motor port 1912 is preferably located at the lower end of the charging and distributing device 191 close to the drive motor 121, facilitating wiring layout. The charging and distributing device 191 provides electricity to the heat transfer system 162, such as to drive the water pump 1625 (shown in FIGS. 4 and 5), water heater 1623 and compressor 1622. Placing the charging and distributing device 191 on the (left) side with the drive motor 121 helps avoid interference with the heat transfer system 162 substantially located on the other (right) side of the longitudinal midplane 103.

The charging and distributing integrated system 19 includes a charging port 192 electrically connected to the charging and distributing device 191. To charge the power battery 161, a user connects an external power source (not shown) to the charging port 192 via an external charging cable (not shown). The charging port 192 is preferably exposed for electrical connection off the rear of the vehicle 100.

A cooling pipeline 194 is at least partially disposed within the charging and distributing device 191, and the cooling pipeline 194 is connected to the condenser 1627, so that the coolant in the cooling pipeline 194 can transfer the heat generated during operation of the charging and distributing device 191 to the condenser 1627. This reduces the temperature of the charging and distributing device 191, thereby improving operational stability and extending the lifespan of the charging and distributing device 191. Using the condenser 1627 of the heat transfer system 162 to cool the power charging and distributing device 191 rather than an independent condenser reduces part count in the electric off-road vehicle 100. Alternatively, a separate condenser (not shown) could be fluidly connected to the power charging and distributing device 191.

The cargo area 21 of the electric off-road vehicle 100 is used for holding items and transporting materials. The cargo area 21 is located above the rear frame 112. FIG. 15 shows the preferred elevational positioning of the power charging and distributing device 191 relative to the drive motor 121 and the cargo area 21. In plan view, all three of the cargo area 21, the power charging and distributing device 191 and the drive motor 121 at least partially overlap, with the power charging and distributing device 191 disposed between the drive motor 121 and the cargo area 21. Positioning the charging and distributing device 191 between the drive motor 121 and the cargo area 21 helps shield and protect the charging and distributing device 191 during travel of the electric off-road vehicle 100. A minimum charging and distributing clearance height H1 between the charging and distributing device 191 and the drive motor 121 is preferably in the range from 2 to 4 cm, more preferably in the range from 2.4 to 3.6 cm, and most preferably in the range from 2.7 cm to 3.3 cm. An adequate minimum charging and distributing clearance height H1 helps keep the drive motor 121 from bumping against the charging and distributing device 191 during vehicle operation, avoiding damage to the charging and distributing device 191, and thereby increasing the service life of the charging and distributing device 191.

Portions of the frame 11 are further shown with reference to FIGS. 16-20. The frame 11 preferably includes left and right rear cockpit posts 114 extending generally vertically in line with the back of the seating 15. Left and right rear sloped columns 115 extend upwardly and rearwardly from low ends 1141 of the respective rear cockpit posts 114. A mid cabinback barrier crossbar 116 extends laterally between the rear cockpit posts 114. The mid cabinback barrier crossbar 116 is at an elevation equivalent to the bottom of the cargo area 21, roughly at the same height as the seat bracket 152, and serves in part to separate the cockpit 101 and the rearframe 112.

The charging and distributing device 191 is mounted from a charging and distributing support 117. The charging and distributing support 117 includes left and right fixing brackets 1171, an arched crossbar 1172, a middle downbar 1173 and left and right fixing pedestals 1174. The fixing brackets 1171 and the fixing pedestals 1174 are preferably formed of sheet metal, while the arched crossbar 1172 and the middle downbar 1173 are preferably formed of metal tubing bent into the shapes shown. The arched crossbar 1172 is bent so as to arch upwardly and rearwardly over at least a portion of the prime mover assembly 12, such as over the drive motor 121. The fixing brackets 1171 are used to rigidly attach ends 1175 of the arched crossbar 1172 relative to the rear cockpit posts 114 and/or relative to the rear sloped columns 115 and/or relative to ends 1161 of the mid cabinback barrier crossbar 116. In the preferred embodiment shown, each fixing bracket 1171 attaches to both the respective (left or right) rear cockpit post 114 and to the respective rear sloped column 115, so the fixing bracket 1171, rear cockpit post 114 and rear sloped column 115 jointly form a stable triangle on the frame 11 just in front of the respective rear wheel 142. The middle downbar 1173 is attached at a mid location 1162 of the mid cabinback barrier crossbar 116, extending downwardly and rearwardly therefrom to the arched crossbar 1172 so as to support a mid location of the arched crossbar 1172 from the mid cabinback barrier crossbar 116. The fixing pedestals 1174 are used to attach and support the charging and distributing device 191. When the charging and distributing device 191 is secured using the fixing pedestals 1174, at least a portion of the charging and distributing device 191 overlaps with at least a portion of the drive motor 121 in plan view. The charging and distributing support 117 avoids interference between the prime mover assembly 12 and the charging and distribution device 191, thereby providing more installation space for the charging and distribution device 191. The charging and distributing support 117 has excellent connection strength with the rest of the frame 11, and stability of the charging and distributing device 191 on the charging and distributing support 117 is enhanced.

The charging and distributing support 117 supports the charging and distributing device 191 rearward of the power battery 161. Interference between the charging and distributing device 191 and the power battery 161, which could otherwise occur when the charging and distributing device 191 and the power battery 161 are arranged in close contact, is avoided. At the same time, wiring length between the charging and distributing device 191 and the power battery 161 is kept low.

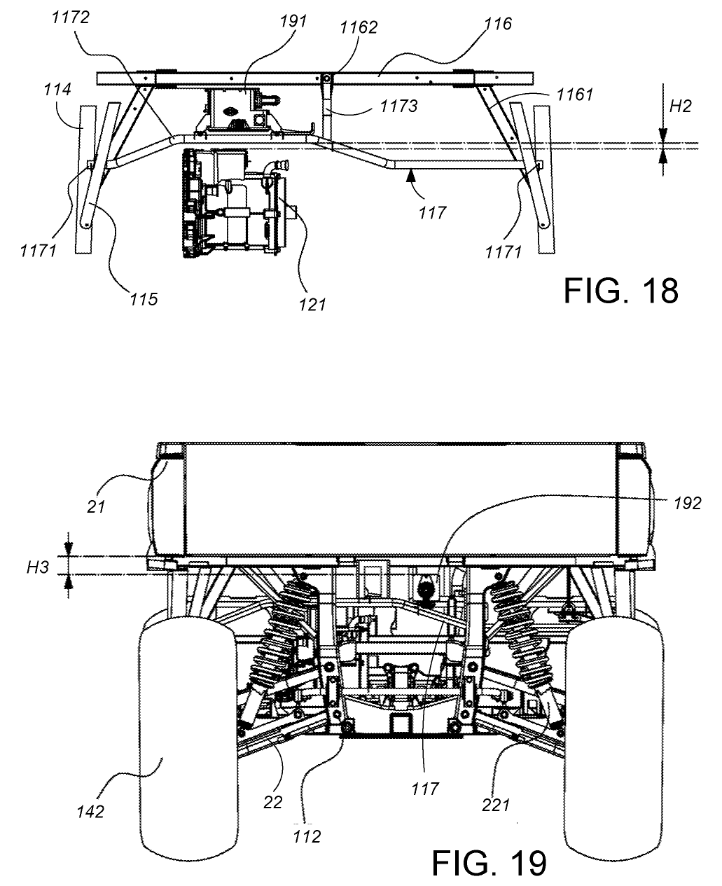

The arched crossbar 1172 of the charging and distributing support 117 has an arched crossbar gap height H2 over the drive motor 121 as called out in FIG. 18. The arched crossbar gap height H2 is preferably in the range from 2 to 3.5 cm, more preferably in the range from 2.3 to 3.4 cm, and most preferably in the range from 2.6 cm to 3.1 cm. An appropriate arched crossbar gap height H2 prevents contact between the arched crossbar 1172 and the drive motor even when the electric off-road vehicle 100 is driven in harsh road conditions so as to create vibrations.

The suspension system 22 includes two (left and right) rear shock absorbers 221. The rear shock absorbers 221 reduce vibration transmission between the rear wheels 142 and the frame 11 to improve the driving comfort of the electric off-road vehicle 100. The charging port is at least partially disposed between the two rear shock absorbers 221, entirely below the cargo area 21 but at least partially above an elevation of the rear wheels 142. A minimum charging port gap height H3 is defined between the cargo area 21 and the charging port 192 as called out in FIG. 19. The minimum charging port gap height H3 is preferably in the range from 7.6 to 14 cm, more preferably in the range from 8.6 to 13 cm, and most preferably in the range from 9.7 to 11.9 cm. An appropriate charging port gap height H3 positions the charging port 192 far away from the ground while protected under the cargo area 21, while still avoiding interference between the charging port 192 and the cargo area 21 even when the cargo area 21 is turned upward to dump material. An appropriate charging port gap height H3 also minimizes the amount of mud and sand thrown on the charging port during driving of the electric off-road vehicle 100.

A cargo area overhang L2 is defined as the longitudinal distance between the rearmost end of the charging port 192 and the rearmost end of the cargo area 21. The cargo area overhang L2 is preferably in the range from 58.8 to 109.2 mm, more preferably in the range from 67.2 to 100.8 mm, and most preferably in the range from 75.6 to 92.4 mm. A cargo area overhand L2 in the preferred range keeps the entirety of the charging port 192 protected under the cargo area 21 while still allowing accessibility for charging connection.

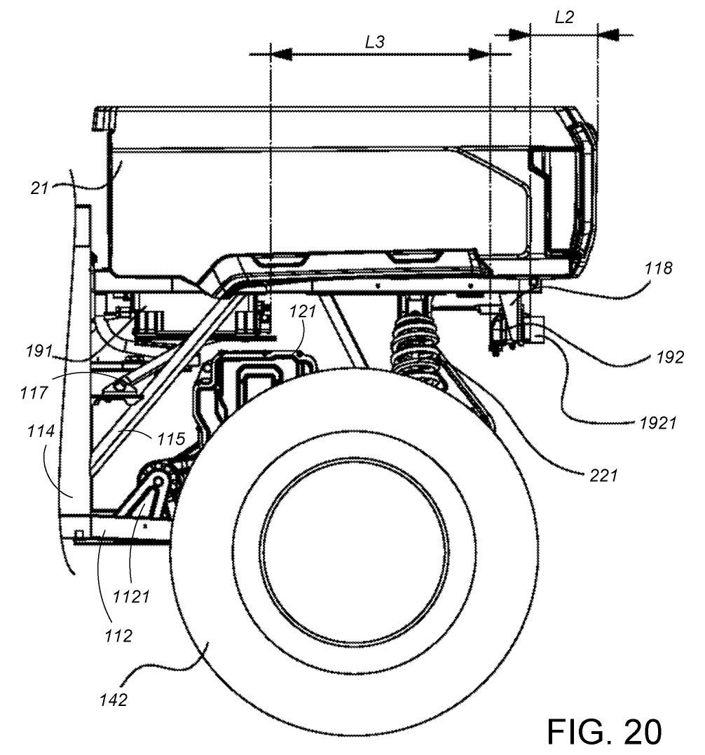

A charging port wiring length L3 is defined as the longitudinal distance between a rear end of the charging and distributing device 191 and a front side of the charging port 192 as called out in FIG. 20. The charging port wiring length L3 is preferably in the range from 31.9 to 59.3 mm, more preferably in the range from 36.5 to 54.7 mm, and most preferably in the range from 41 to 50.2 mm. A charging port wiring length L3 in the preferred range reduces connection line length between the charging and distributing device 191 and the charging port 192 and improves working efficiency of charging.

The frame 11 preferably includes a charging port mounting bracket 118. The charging port 192 at least partially passes through the charging port mounting bracket 118 and is fixedly connected to the charging port mounting bracket 118 so as to face rearwardly and perhaps slightly downwardly. Use of the charging port mounting bracket 118 improves connection strength of the charging port 192 and helps protect the charging port 192 against inadvertent collisions. Downward angling of the charging port 192 can help prevent dust and rainwater from entering the charging port 192. A charging cover 1921 is preferably hingedly connected to the charging port 192. The charging cover 1921 provides additional protection for the charging port 192 to avoid sand, dust, rain and other contaminants from entering into the charging port 192, and to protect the charging port 192 and components connected to the charging port 192.

It should be understood that the specific embodiments described herein in a relatively specific and detailed manner are examples merely intended to illustrate the present invention and are not intended to limit it in any way. The present invention may also be applied to many other similar situations. Based on the embodiments provided herein, all other modifications and improvements that can be obtained by those of ordinary skill in the art, even though their work may be complex and time-consuming, shall fall within the scope of protection of the present invention as defined by the appended claims.

1. An electric off-road vehicle comprising:
a frame defining a longitudinal midplane of the off-road vehicle;
front wheels and rear wheels supporting the frame through a suspension system;
a prime mover assembly supported by the frame, the prime mover assembly comprising a drive motor and a gear reduction unit connected to the drive motor at a connection surface which is offset from the longitudinal midplane by a PMA connection surface offset, the PMA connection surface offset being within a range of 70 to 140mm;
a power battery for supplying electricity to the drive motor;
a drive train transferring torque from the prime mover assembly to both the front wheels and the rear wheels, the drive train comprising a drive shaft which extends under the power battery; and
seating supported by the frame, the seating being at least partially located forward of the power battery in plan view, wherein from 52 to 100% of the seating extends over the power battery in plan view.

2. The electric off-road vehicle of claim 1, wherein the power battery is oriented so as to be longest in width and shortest in height, wherein the drive shaft is a front drive shaft, and wherein the drive train further comprises a front differential and a rear differential, the rear differential being located rearward of the prime mover assembly.

3. The electric off-road vehicle of claim 2, wherein the power battery defines a drive shaft accommodating recess, wherein the front drive shaft is at least partially disposed within the drive shaft accommodating recess.

4. The electric off-road vehicle of claim 3, wherein the power battery comprises a battery housing having an upper battery housing and a lower battery housing, wherein the drive shaft accommodating recess is defined in the lower battery housing.

5. The electric off-road vehicle of claim 4, wherein the rear differential is directly mounted on the gear reduction unit.

6. The electric off-road vehicle of claim 5, wherein the prime mover assembly and the rear differential are mounted on the off-road vehicle using a support cradle, the support cradle having three hangers comprising:
a left-front hanger supporting one of the drive motor and the gear reduction unit from the frame;
a right-front hanger supporting another of the drive motor and the gear reduction unit from the frame; and
a rear hanger supporting the rear differential from the frame.

7. The electric off-road vehicle of claim 6, wherein each hanger comprises a bushing for providing cushioning and a bracket for connecting the prime mover assembly and rear differential relative to the bushing, wherein the bracket for the left-front hanger contacts the prime mover assembly on a longitudinally extending vertical surface, wherein the bracket for the right-front hanger contacts the prime mover assembly on a longitudinally extending vertical surface, and wherein the bracket for the rear hanger contacts the rear differential on a transversely extending vertical surface.

8. The electric off-road vehicle of claim 1, wherein the power battery has a maximum power battery width, wherein the frame has a maximum frame width, and wherein a power battery width ratio of the maximum power battery width to maximum frame width is in the range from 0.5 to 1.

9. The electric off-road vehicle of claim 1, further comprising a heat transfer system for the power battery, the heat transfer system using a liquid heat transfer medium.

10. The electric off-road vehicle of claim 9, wherein the heat transfer system comprises a pump located rearward of the power battery and forward of the rear differential.

11. The electric off-road vehicle of claim 10, wherein the heat transfer system further comprises a heater for heating the liquid heat transfer medium, the heater being located rearward of the power battery and forward of the rear differential.

12. The electric off-road vehicle of claim 10, wherein the heat transfer system further comprises:
a refrigerant compressor located rearward of the power battery and forward of the rear differential; and
an evaporator heat exchanger located rearward of the power battery and forward of the rear differential, wherein both liquid heat transfer medium and refrigerant separately flow through and are capable of exchanging heat in the evaporator heat exchanger.

13. The electric off-road vehicle of claim 1, further comprising:
a charging and distributing device disposed at least partially on a rear side of the power battery above the prime mover assembly, the charging and distributing device being electrically connected to the power battery and electrically connected to the drive motor.

14. The electric off-road vehicle of claim 13, wherein the charging and distributing device is positioned above the drive motor, and wherein a minimum charging and distributing clearance height between the charging and distributing device and the drive motor is in the range from 2 to 4 cm.

15. The electric off-road vehicle of claim 14, wherein the charging and distributing device is supported by a charging and distributing support having an arched crossbar and at least one fixing pedestal, the arched crossbar being bent so as to arch upwardly and rearwardly so the at least one fixing pedestal supports the charging and distributing device over the drive motor.

16. An electric off-road vehicle comprising:
a frame defining a longitudinal midplane of the off-road vehicle;
front wheels and rear wheels supporting the frame through a suspension system;
a prime mover assembly supported by the frame, the prime mover assembly comprising a drive motor and a gear reduction unit connected to the drive motor at a connection surface which is offset from the longitudinal midplane by a PMA connection surface offset;
a power battery for supplying electricity to the drive motor;
a drive train transferring torque from the prime mover assembly to both the front wheels and the rear wheels, the drive train comprising a drive shaft, a front differential and a rear differential, the drive shaft overlapping with the power battery in plan view;
seating supported by the frame, the seating being at least partially located forward of the power battery in plan view, the seating at least partially extending over the power battery in plan view; and
a heat transfer system for the power battery, the heat transfer system using a liquid heat transfer medium, the heat transfer system comprising:
a pump located rearward of the power battery and forward of the rear differential.

17. The electric off-road vehicle of claim 16, wherein the gear reduction unit has a gear reduction width, wherein the gear reduction unit is connected to the drive motor at a connection surface which is offset from the longitudinal midplane by a PMA connection surface offset, the PMA connection surface offset being 34 to 49% of the gear reduction width.

18. The electric off-road vehicle of claim 17, wherein the gear reduction unit comprises a power input shaft driven by the drive motor and a power transmission shaft coupled to the power input shaft, the power transmission shaft transmitting torque to the drive shaft and the rear differential, wherein the power transmission shaft is parallel to the power input shaft, with an axis of the power transmission shaft being longitudinally offset from an axis of the power input shaft by a gearshaft separation distance which is in the range from 74 to 138 mm.

19. An electric off-road vehicle comprising:
a frame defining a longitudinal midplane of the off-road vehicle;
front wheels and rear wheels supporting the frame through a suspension system;
a prime mover assembly supported by the frame, the prime mover assembly comprising a drive motor and a gear reduction unit connected to the drive motor;
a power battery for supplying electricity to the drive motor, the power battery being oriented so as to be longest in width and shortest in height, the power battery defining a drive shaft accommodating recess;
a drive train transferring torque from the prime mover assembly to both the front wheels and the rear wheels, the drive train comprising a front drive shaft, the front drive shaft extending under the power battery in plan view, wherein the front drive shaft is at least partially disposed within the drive shaft accommodating recess; and
seating supported by the frame, the seating being at least partially located forward of the power battery in plan view, the seating at least partially extending over the power battery in plan view.

20. The electric off-road vehicle of claim 19, wherein the power battery has a maximum power battery width, wherein the frame has a maximum frame width, and wherein a power battery width ratio of the maximum power battery width to maximum frame width is in the range from 0.5 to 1.
